(19) United States
(12) Patent Application Publication
(10) Pub. No.: US 2013/0094838 A1
(43) Pub. Date: Apr. 18, 2013

(54) OPTICAL DISC PLAYER WITH IMPROVED CONTENT PLAYBACK

(71) Applicants: Joseph M. Freund, Fogelsville, PA (US); John M. DeLucca, Wayne, PA (US)

(72) Inventors: Joseph M. Freund, Fogelsville, PA (US); John M. DeLucca, Wayne, PA (US)

(21) Appl. No.: 13/274,494

(22) Filed: Oct. 17, 2011

(51) Int. Cl. H04N 9/80

(52) U.S. Cl. 386/262; 386/248; 386/E05.003

(57) ABSTRACT

A method for managing playback of special feature content on an optical disc, comprising the steps of (A) storing a first disc specific information set for a particular disc in the memory of an optical disc player and (B) prior to playback of a main feature content, comparing a previously stored second disc specific information to the first disc specific information of a current disc and (C) if a match occurs between the first disc specific information and the second disc specific information, skipping the loading or playback of the special feature content on the optical disc and playing said main feature content.

### FIELD OF THE INVENTION

The present invention relates to optical disc players generally and, more particularly, to a method and/or apparatus for implementing an optical disc player with improved content playback.

### BACKGROUND OF THE INVENTION

With the advent of the Blu-ray standard, conventional optical disc titles often contain a large amount of special features. The format used to run these features is JAVA. Conventional Blu-ray players load JAVA when a disc is first loaded. A delay of up to several minutes can occur while loading JAVA features before the actual movie can be played. Many users have no interest in the special features and do not want to wait for the JAVA to load. These users just want to watch the movie with as short of wait as possible.

Other conventional DVD and/or Blu-ray players read and display special feature content from a disc that contains data that is often encoded in the MPEG-2 format. The MPEG-2 information is often in addition to the JAVA content that can also exist on the disc. The disc and/or player typically force the user to watch obligatory MPEG-2 content, such as previews of upcoming movies or product advertisements, prior to allowing the user to view the main feature of the disc. Mandatory trailers can be useful in a rental situation. However, when a user owns a disc, and has seen the obligatory preview content previously, the preview content is undesirable. Additionally, the information in the preview content may be out-of-date (such as an advertisement for a product that is no longer made) and has little or no relevant value. In contrast to the desire to skip advertisements and previews, the disc manufacturers and content providers have an interest in ensuring that preview content is watched by the user.

It would be desirable to implement an optical disc player that has firmware that recognizes when a disc with JAVA is loaded, then prompt the user with a screen to ask the user to load one or more special features or proceed to watching the movie.

It would also be desirable to implement an optical disc player that makes preview content obligatory when loading and viewing the disc content under one or more predetermined conditions.

### SUMMARY OF THE INVENTION

The present invention concerns a method for managing playback of special feature content on an optical disc, comprising the steps of (A) storing a first disc specific information set for a particular disc in the memory of an optical disc player and (B) prior to playback of main feature content, comparing a previously stored second disc specific information to the first disc specific information of a current disc and (C) if a match occurs between the first disc specific information and the second disc specific information, skipping the loading or playback of the special feature content on the optical disc and playing the main feature content.

The objects, features and advantages of the present invention include providing an optical disc player that may (i) provide a user with the ability chose when, if at all, to have special features loaded, (ii) make the operation of an optical player more efficient, (iii) begin loading the JAVA content during a time that is transparent to the user, (iv) present preview content at least one time for each disc, and/or (v) prompt a user to skip previously viewed content.

### BRIEF DESCRIPTION OF THE DRAWINGS

These and other objects, features and advantages of the present invention will be apparent from the following detailed description and the appended claims and drawings in which:

FIG. 1 is a block diagram illustrating an optical disc player in accordance with the present invention;

FIG. 2 is a row diagram illustrating an initial loading of a disc;

FIG. 3 is a flow diagram illustrating a determination of whether special feature content should be played or not; and

FIG. 4 is a diagram illustrating a determination of whether special feature content should be retrieved.

### DETAILED DESCRIPTION OF THE PREFERRED EMBODIMENTS

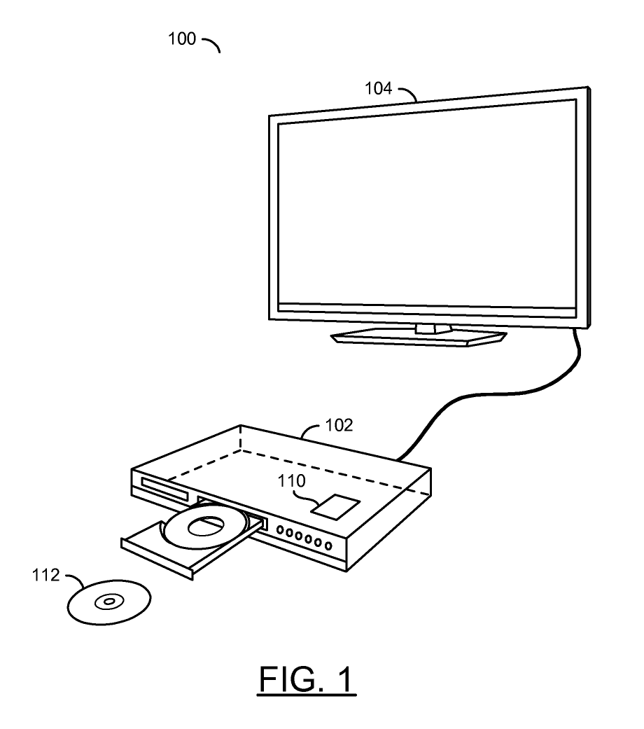

Referring to FIG. 1, a block diagram of a system 100 is shown in accordance with a preferred embodiment of the present invention. The system 100 generally comprises a block (or circuit) 102 and a block (or circuit) 104. The circuit 102 may be implemented as an optical disc player. In one example, the optical disc player 102 may be implemented as a DVD player. In another example, the optical disc player 102 may be implemented as a Blu-ray player. The circuit 104 may be implemented as a display device, such as a digital television (DTV), plasma screen, LCD screen, or other appropriate display device. The player 102 may include a block (or circuit) 110. The circuit 110 may be a memory and/or processor configured to store computer readable code that, when executed, performs various steps. The memory 110 may include a non-volatile portion that may be used to store data after the player 102 is powered down. A disc 112 may be inserted and/or removed from the player 102. In one example, the disc 112 may be a removable optical disc (e.g., DVD, Blu-ray, etc.).

The disc 112 may contain both special feature content and main feature content. Special feature content (or preview content) may be defined as one or more of (i) special features implementing JAVA and/or non-JAVA format, (ii) advertisements, and/or (iii) trailers in either MPEG2, MPEG4, or other format (e.g., Window Media WM), BluRay Disc Media (BDM), etc.). Main feature content may be defined as a movie (e.g., include a number of chapters, scenes, etc.), a television series (e.g., including a number of chapters, scenes, etc.) or other feature video. In general, the main feature content may occupy most of the disc space. However, the particular amount of disc space used by the main feature may be varied to meet the design criteria of a particular implementation.

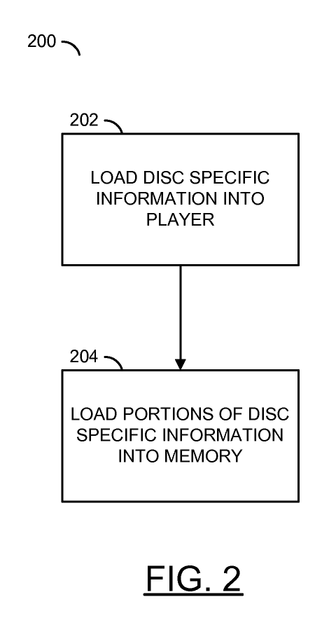

Referring to FIG. 2, a diagram of a method (or process) 200 is shown. The method 200 may initialize the player 102 for a particular disc 112. The method 200 generally comprises a step (or state) 202, and a step (or state) 204. The step 202 may load disc specific information into the optical player 102. The step 204 may load the disc specific information into the memory 110 of the optical disc player 102. The disc specific information may be a set of information that identifies the disc 112 to the player 102. An example of disc specific information that may be used to identify a disc may include one or more pieces of information and/or attributes stored on the disc 112. For example, information about a Blu-ray or DVD file directory, a data and/or time the disc 112 was recorded by a manufacturer, or other information may be used as disc specific information. However, the particular type of disc specific information may be varied to meet the design criteria of a particular implementation. The disc specific information of a particular disc 112 may be sufficient to provide a unique identification compared with other discs that may be inserted in the player 102. The disc specific information may be stored in a non-volatile portion of the memory 110.

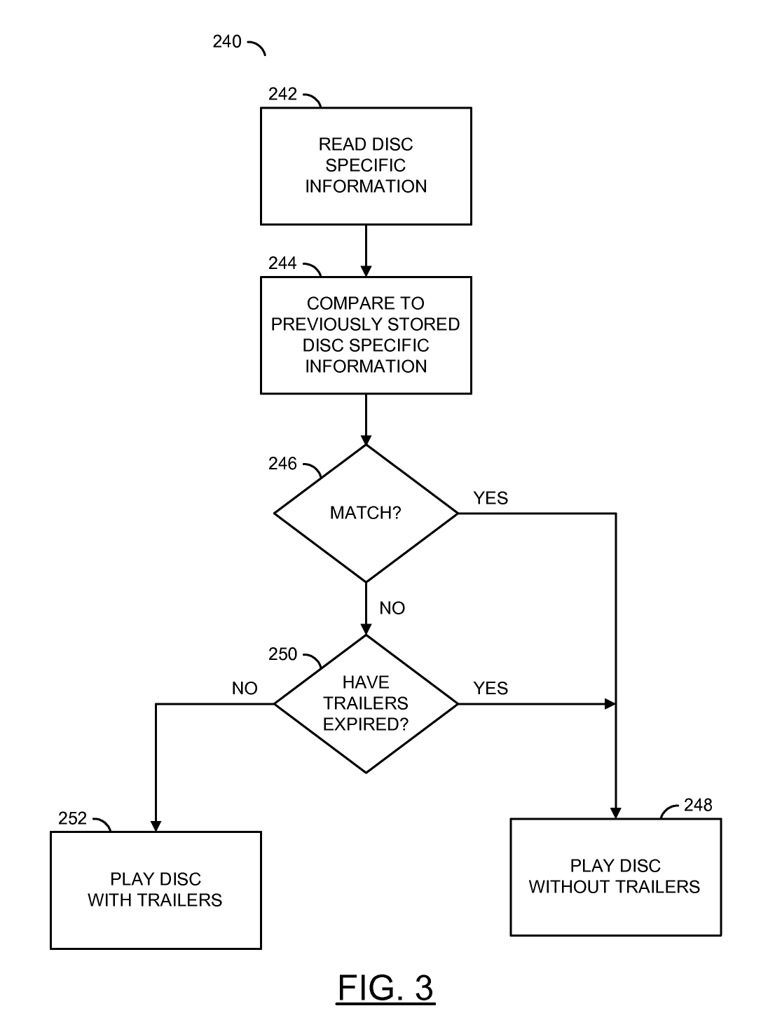

Referring to FIG. 3, a method (or process) 240 is shown. The method 240 generally comprises a step (or state) 242, a step (or state) 244, a decision step (or state) 246, a step (or state) 248, a decision step (or state) 250, and a step (or state) 252. The step 242 may read the disc specific information stored in the step 204. Next, the method 240 moves to the state 244. The state 244 compares the disc specific information from the step 242 to the previously stored disc specific information from the step 204. Next, the method 240 determines if a match has occurred. If a match has occurred, this normally indicates that the trailer information (or special feature content) has already been played. Therefore, the method 240 moves to the state 248. In the state 248, the disc 112 is played without the trailer information. If the state 246 determines that a match has not occurred, the method 240 may move to the state 250. The state 250 may determine if the trailer information has expired. If so, the method 240 moves to the state 248, where the disc is played without the trailers. If the decision state 250 determines that the trailers have not expired, the method 240 moves to the state 250 where the disc is played with the trailers. In general, the steps of the method 240 may be performed each time a disc is loaded into the player 102.

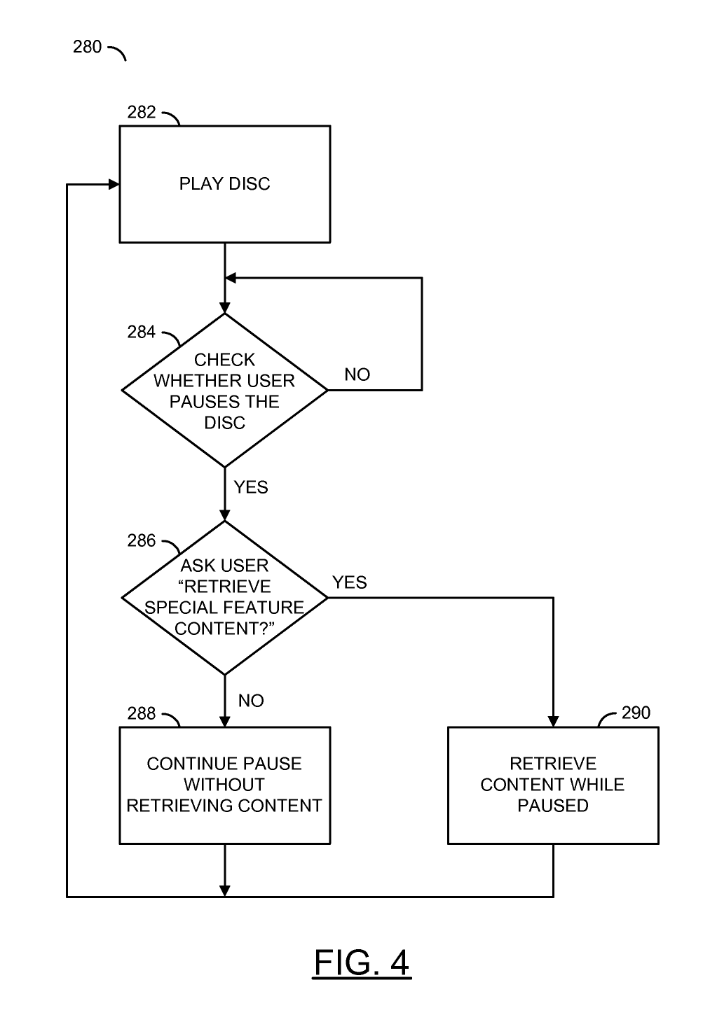

Referring to FIG. 4, a method (or process) 280 is shown. The method 280 generally comprises a step (or state) 282, a step (or state) 284, a decision step (or state) 286, a step (or state) 288 and a step (or state) 290. The step 282 normally starts playing the disc 112. Next, the step 284 checks whether a user pauses the disc playback. If a user does not pause the disc playback, the method 280 may continue to check whether the user pauses the disc playback. If the user does pause the disc playback, then the method 280 moves to the decision state 286. While the decision state 284 has been described as a polling configuration of whether a user has paused a disk, the particular implementation of step 284 may be varied to meet the design criteria of a particular implementation. For example, an interrupt type configuration may be implemented. In such an example, the method 280 may continue in the play disk state 282 until the user has initiated a pause, which may trigger an interrupt to proceed to the state 286.

The decision state 286 generally provides a prompt such as “retrieve special feature content?”. The user then presents a response, such as a “YES” or a “NO”. If a user declines the option to retrieve the special feature content, the method 280 moves to the state 288. If the user confirms playing of the special feature content, or if the user fails to respond after a predetermined time, the method 280 moves to the state 290. In the state 288, the disc continues pausing without retrieving the special feature content. In the state 290, the method 280 retrieves the special feature content while the disc is paused. After the state 288 and/or the state 290, the method 280 normally returns to the state 282. In one example, the special feature content may continue to be retrieved while the disc is paused. However, if the special feature content is not completely retrieved prior to a user resuming playback, a second alternate prompt may be presented (e.g., “Continue to retrieve special feature content?”). However, the particular message in the user prompt may be varied to meet the design criteria of a particular implementation.

In an alternate embodiment, a user may program the player 102 to suppress downloading of special feature content unless an affirmative confirmation by the user has been received in the step 286. For example, a default setting in a set-up menu of the player 102 may be implemented. Additionally, if the special feature content has not loaded while the disc playback was paused, the player 102 may remember where the download had previously left off, and then continue loading content on a subsequent pause.

Additionally, a prompt for the step 286 may be initiated at any point during the playback of a movie. For example, if the user wants to initiate a pause, and load the special feature content, a separate hardware button may be triggered. For example, a “red” (or other color) key may be implemented on a remote to initiate loading the special feature content.

The system 100 may include a feature that may enable disc manufacturer and/or disc content providers to control when or how often preview content is obligatorily viewed by the user when a disc 112 is played in the optical disc player 102. Such a feature may be enabled and/or disabled during the authorizing process of each disc 112. For example, the memory 110 may contain combinations of logic and/or software configured to track when content has been previously viewed. In one example, a small amount of specific data content may also be stored on the optical disc 112. In another example, the information may be written directly to the disc 112. In such a case, a read/write (R/W) player (e.g., DVD RW, Blu-ray R/W, etc.) and/or R/W discs may be implemented.

In general, the system 100 may indicate that the first time a disc 112 is played, the viewer(s) may be forced to watch all of the trailers and/or any other advertising materials. At the conclusion of the advertisements, either automatically or via a menu prompt (e.g., by asking the viewer if they would like to disable the advertisements), the system 100 may write an identifier directly on the disc 112. The identifier may indicate that the advertisements had been watched at least once. The viewing of the advertisements may then be disabled the next time the movie was played. While a single viewing has been described, the particular number of viewings (e.g., two, three, . . . ) may be varied in the design criteria of a particular implementation.

In one example, where the playback device 102 is not a recorder, the date that the disc was manufactured may be read from the disc and compared to the current date. If the difference between the dates exceeds some default or set duration (e.g., 1 year), the advertisement may be skipped over. Such an implementation may force a user to watch the advertisements for a specific time (e.g., up to one year). In the case of JAVA downloads, postponing the download to a more convenient time (e.g., when the player is paused) may be implemented. Such a delay may implement a partial download solution. For example, when the disc is initially loaded, the most important features of JAVA may be downloaded. The less used “special features” may be downloaded later during pause intervals. Such an implementation may reduce the wait time during start up, while maintaining particular features that JAVA may provide. Alternately, if the user decides to stop the playback and/or turnoff the player 102 before completely watching the main feature content, the player 102 may be configured to finish loading the JAVA before initiating a full power down. The player 102 may be configured to confirm that the disc 112 is still loaded in the player 102, which may indicate that the user is going to finish watching the movie later.

In one example, the player 102 may begin playing the main feature content without JAVA features. The player 102 may then load the JAVA special features content while the main feature content is paused. The player 102 may automatically resume playback of the main feature content once the user presses play again. In such an example, loading of the special features content may be transparent to the user. The player 102 may be waiting to load the special feature content, but only at a time that is convenient and/or not noticeable to the user.

After the optical disc 112 is loaded, the player 102 may read certain data specific to the disc 112 being played. The disc specific information may be stored into the memory 110. In one example, the disc specific information may be stored in memory after some (or all) of the special feature content has been played/viewed by the user. Such an implementation may ensure that the special feature content was played at least once on the optical disc player 102. Operations of the player 102 may continue and the user may then play/view the main feature content. If the user then loads the same disc 112 at a later date (e.g., to continue watching an unfinished movie or watching the same movie again), the player 102 may once again read the disc specific information of the disc 112 being played. The disc specific information may be compared to data stored in memory 110. The player 102 may recognize that the special feature content was previously played/viewed and the player 102 would then either automatically skip over the special feature content or allow the user to do so manually and proceed to the main feature. The special feature content would be skipped (either automatically or manually) during subsequent loadings of the disc 112. The skip feature may operate as long as the disc specific data continues to be stored in the memory 110.

In another example, the player 102 may read the disc specific information from the disc 112 being played. The disc specific information may be stored in the memory 110. The player 102 may then remember and store how many times the special feature preview content was played/viewed. In one example, a counter may store the playback history in the memory 110.

The memory 110 may store how many times a particular disc 112 was played in the player. Alternately, the memory 110 may store how many times a particular special feature content (such as a movie trailer) was played. For example, if a particular movie trailer was inserted at the front of several discs (perhaps by the same disc manufacturer), the player 102 may recognize that the content had been previously played and may be skipped. The disc 112 may contain information that instructs the player 102 how many times the preview content must be played/viewed by the user before the preview content is automatically skipped (or allowed to be manually skipped) in subsequent disc viewing sessions.

In another example, the disc 112 may be encoded with a date, after which the preview content may be skipped. The player 102 may read the date from the disc 112 and compare the date to a date stored in the memory 110 to determine if the content may be skipped. Alternatively, the player 102 may store the date on which the preview content of the disc 112 was first played/viewed and may compare this date to that of subsequent viewings of the disc 112. After a certain amount of time prescribed by the disc has elapsed, the preview content may be skipped. In one example, the disc-specific information may be stored directly to the disc 112.

The functions performed by the diagrams of FIGS. 3 and 4 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A method for managing playback of special feature content information on an optical disc, comprising the steps of:
(A) storing a first disc specific information set for a particular disc in the memory of an optical disc player;
(B) prior to playback of a main feature content, comparing a previously stored second disc specific information to said first disc specific information of a current disc; and
(C) if a match occurs between said first disc specific information and said second disc specific information, skipping the loading or playback of said special feature content on said optical disc and playing said main feature content.

2. The method according to claim 1, further comprising the step of:
prior to skipping a playback of said trailer information, prompting a user whether said special feature content should be displayed.

3. The method according to claim 1, where said special feature content comprises trailer information.

4. The method according to claim 1, wherein said special feature content comprises JAVA based information.

5. The method according to claim 4, further comprising the steps of:
determining whether a user has initiated a pause during the playback of said main feature; and
downloading said JAVA based information while said pause is active.

6. The method according to claim 5, wherein said downloading is completed after said player has been turned off.

7. The method according to claim 1, wherein said memory comprises a non-volatile memory.

8. The method according to claim 1, wherein said previously stored second disc specific information comprises information concerning an age of said special feature content.

9. The method according to claim 8, wherein said special feature content is skipped if said age is older than a predetermined age.

10. The method according to claim 1, wherein said first disc specific information is stored on a said optical disc.

11. The method according to claim 10, wherein said optical disc player is selected from the group consisting of a DVD recorder and a Blu-ray recorder.

12. The method according to claim 1, wherein said optical disc player is selected from the group consisting of a DVD player and a Blu-ray player.

13. An apparatus comprising:
an optical disc player including a memory, said memory configured to store instructions in a computer readable medium, said instructions configured to (A) store a first disc specific information set for a particular disc in the memory of an optical disc player, (B) prior to playback of a main feature content, compare a previously stored second disc specific information to said first disc specific information of a current disc and (C) if a match occurs between said first disc specific information and said second disc specific information, skip the loading or playback of said special feature content on said optical disc and playing said main feature content.

14. The apparatus according to claim 13, wherein said instructions are further configured to skip a playback of said trailer information, prompting a user whether said special feature content should be displayed.

15. The apparatus according to claim 13, where said special feature content comprises trailer information.

16. The apparatus according to claim 13, wherein said special feature content comprises JAVA based information.

17. The apparatus according to claim 13, wherein said instructions are further configured to:
determine whether a user has initiated a pause during the playback of said main feature; and
download said JAVA based information while said pause is active.

18. The apparatus according to claim 13, wherein said memory comprises a non-volatile memory.

19. The apparatus according to claim 13, wherein said instructions are further configured to (i) store a number representing how many times said special feature content has been viewed and (ii) skip said special feature content only after a predetermined number of times said special feature content has been viewed has been met.

20. The apparatus according to claim 19, wherein said number is stored in a counter.
